(19) United States
(12) Patent Application Publication
(10) Pub. No.: US 2012/0274174 A1
(43) Pub. Date: Nov. 1, 2012

(54) ROTARY ELECTRIC MACHINE STATOR

(75) Inventor: Hirokazu UCHIDA, Toyota-shi (JP)

(73) Assignee: TOYOTA JIDOSHA KABUSHIKI KAISHA, Toyota-shi (JP)

(21) Appl. No.: 13/455,901

(22) Filed: Apr. 25, 2012

(30) Foreign Application Priority Data
Apr. 27, 2011 (JP) 2011-099488

(51) Int. Cl. H02K 1/16

(52) U.S. Cl. 310/254.1

(57) ABSTRACT

A stator includes annular segment assembly portions of phases wound on a stator core in a distributed winding manner. The annular segment assembly portion of each phase includes segment coils that are each formed in a coil shape by connecting conductor segments to each other. An annular protrusion-equipped electrical insulation sheet is inserted between two conductor segments adjacent to each other in the radial direction in a turn portion-side coil end portion that is formed of portions of the segment coils which portions are protruded to an outer side from an end surface of the stator core in the axial direction. The protrusion-equipped electrical insulation sheet has a protrusion that is provided on an end edge of an annular main body portion on the side opposite to the stator core side in the axial direction so that the protrusion is protruded in the axial direction from the end edge.

### INCORPORATION BY REFERENCE

The disclosure of Japanese Patent Application No. 2011-099488 filed on Apr. 27, 2011 including the specification, drawings and abstract is incorporated herein by reference in its entirety.

### BACKGROUND OF THE INVENTION

1. Field of the Invention

The invention relates to a rotary electric machine stator that includes a stator core having slots that are formed at plurality of locations spaced from each other in a circumferential direction, and a plurality of annular segment assembly portions of phases wound on the stator core in a distributed winding manner.

2. Description of Related Art

There has been available a structure of a stator of a rotary electric machine in which a stator core that has grooves called slots extending in radial directions that are juxtaposed in the circumferential direction is provided, and stator coils are wound on the stator core in the distributed winding manner so that each stator coil is inserted into two slots that are apart from each other in the circumferential direction.

In this structure, it is also conceivable to provide the stator coils as segment coils that are each formed in a coil shape by connecting a plurality of conductor segments to each other. For example, each conductor segment is formed in a U shape by two parallel leg portions and a turn portion that interlinks the two leg portions.

It is also conceivable to construct an annular portion of each phase by providing a plurality of segment coils that are unit coils that are each formed in a coil shape by linking a plurality of conductor segments, and then interlinking the plurality of segment coils in a circumferential direction of the stator core. Incidentally, related-art documents relevant to the invention include Japanese Patent Application Publication No. 2006-166592 (JP 2006-166592 A), Japanese Patent Application Publication No. 2007-104826 (JP 2007-104826 A), and Japanese Patent No. 4461820.

As for a stator that has segment coils that are formed of conductor segments as described above, it is conceivable to restrain partial electric discharge between mutually adjacent conductor segments by disposing electrical insulation sheets between mutually adjacent conductor segments in a coil end portion formed of portions of the segment coils, the portions protruding from an axial end surface of the stator core. For example, JP 2006-166592 A describes that in a segment coil-type stator structure, a circular electrical insulation sheet is inserted between two conductor segments adjacent to each other in a radial direction in a coil end portion on the joint portion side that is opposite to the turn portions of conductor segments. It is also conceivable that an electrical insulation sheet be formed in a circular shape is provided on a turn portion-side coil end portion similarly to the joint portion-side coil end portion.

However, in the case where simple circular electrical insulation sheets are disposed in a coil end portion, there is a possibility that, due to the structure of the segment coils, an electrical insulation sheet cannot be disposed at a position between two segment coils that are coils of different phases, at which position the two segment coils are close to each other. Therefore, there is room for improvement in terms of restraining the partial electric discharge between two segment coils, and there is room for improvement in terms of increasing the interphase PDIV that is an interphase partial discharge inception voltage.

For example, by measuring the interphase PDIV in the case where a simple circular electrical insulation sheet mentioned above is provided in the turn portion-side coil end portion, it has been found that a portion in which the value of the interphase PDIV is conspicuously low exists, and therefore that there is room for improvement in terms of guaranteeing the electrical insulation reliability. Meanwhile, it is also conceivable to secure separation between coils of different phases by lessening the dimensional tolerance of the coils of different phases and increasing the distance between the coils of different phases. However, in the case where an actual stator assembly is manufactured, it is difficult to secure a separation (distance) needed between different-phase coils without increasing the size of the stator because of the shape accuracy and the assembly variations of coils, and there is a possibility of reduction of the interphase PDIV if an insulating sheet is not provided. For example, if different-phase coils partially contact each other, the interphase PDIV becomes small.

Besides, JP 2007-104826 A and Japanese Patent No. 4461820 describe that an interphase electrical insulation sheet that is formed by linking a disposed in-slot portion that is disposed in a slot and a disposed-at-coil end portion that is disposed at an coil end portion integrally to each other in a stator that has a normally used type of coils instead of segment coils. However, neither JP 2007-104826 A nor Japanese Patent No. 4461820 discloses means for effectively improving the interphase PDIV in the coil end portions in a stator that has segment coils that are each formed of conductor segments.

### SUMMARY OF THE INVENTION

The invention effectively improves the interphase PDIV in a coil end portion in a rotary electric machine stator that has segment coils that are each formed of conductor segments.

A rotary electric machine stator in accordance with one aspect of the invention is a rotary electric machine stator that includes; a stator core having slots that are formed at a plurality of locations on an inner circumferential surface of the stator core that are spaced from each other in a circumferential direction of the stator core; a plurality of annular segment assembly portions of phases wound on the stator core in a distributed winding manner, the annular segment assembly portion of each phase including a plurality of segment coils, each of which is formed in a coil shape by connecting a plurality of conductor segments to each other; and an annular electrical insulation sheet inserted between two conductor segments adjacent to each other in a radial direction of the stator core in a coil end portion that is formed of portions of the plurality of segment coils, the portions protruding to an outer side in an axial direction of the stator core from an end surface of the stator core in the axial direction, wherein the electrical insulation sheet includes an annular main body portion formed in an annular shape, and a protrusion that is provided on an end edge of the annular main body portion on a side opposite to the stator core side in the axial direction so that the protrusion is protruded in the axial direction from the end edge.

According to the rotary electric machine stator of the invention, in a construction that has segment coils, each of which is formed of conductor segments, it can be made easy to interpose the protrusion of the protrusion-equipped electrical insulation sheet between two segment coils of different phases in the coil end portion even at a position where, when a simple circularly annular shaped electrical insulation sheet is used, the electrical insulation sheet cannot be interposed between the two segment coils that are close to each other. Therefore, the interphase partial discharge inception voltage (PDIV) in the coil end portion is effectively improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a rotary electric machine stator of an embodiment of the invention, in which insulating sheets are omitted from illustration;

FIG. 2 is a diagram showing a conductor segment that is a component of a stator coil of each phase, in a state before the conductor segment is placed in a stator core;

FIG. 3 is a schematic perspective view of the stator shown in FIG. 1, showing a state in which the stator coils of a U-phase, that is, the stator coils of one phase, have been wound;

FIG. 4 is a diagram in which the stator coils of the U-phase, that is, the stator coils of one phase, are extracted for illustration.

FIG. 5 is a diagram in which, of the stator coils shown in FIG. 4, eight unit coils, the first to eighth coils in terms of winding order in a first half section, are shown;

FIG. 6 is a schematic diagram illustrating a manner in which the eight unit coils of the first half section shown in FIG. 5 are wound on the stator core;

FIG. 7 is a schematic diagram illustrating a manner in which eight unit coils of a second half section are wound on the stator core, following the state shown in FIG. 6;

FIG. 8 is a perspective view showing a circumferential portion of a turn portion-side coil end portion of the stator shown in FIG. 1, in which protrusion-equipped electrical insulation sheets are disposed;

FIG. 9 is a perspective view showing a plurality of protrusion-equipped electrical insulation sheets of annular shapes that are disposed in the turn portion-side coil end portion of the stator shown in FIG. 1;

FIG. 10 is a diagram showing a manner in which two electrical insulation sheet elements are formed out of one belt-shaped electrical insulation sheet in an intermediate process for forming the protrusion-equipped electrical insulation sheet shown in FIG. 9;

FIG. 11A is a schematic view of the stator core and the turn portion-side coil end portion viewed from an outer peripheral side, before a protrusion-equipped electrical insulation sheet is disposed;

FIG. 11B is a schematic view of the stator core and the turn portion-side coil end portion viewed from the outer peripheral side, after the protrusion-equipped electrical insulation sheet has been disposed;

FIG. 12 is a diagram showing a comparative example of a rotary electric machine stator and corresponding to FIG. 8;

FIG. 13 is a perspective view of a plurality of annular electrical insulation sheets that are to be disposed in the turn portion-side coil end portion in the comparative example shown in FIG. 12;

FIG. 14 is a diagram showing a location where the interphase PDIV of adjacent coils becomes small in the turn portion-side coil end portion in the comparative example shown in FIG. 12 while omitting illustration of an electrical insulation sheet;

FIG. 15 is a diagram showing interphase PDIVs between pairs of a U-phase conductor segment and a W-phase conductor segment that are radially adjacent to each other, that is, between different phases, in a region in the circumferential direction, in the comparative example shown in FIG. 12;

FIG. 16 is a diagram showing a manner in which two electrical insulation sheet elements are formed out of one belt-shaped electrical insulation sheet in an intermediate process for forming a first modification of the protrusion-equipped electrical insulation sheet in the embodiment of the invention; and

FIG. 17 is a diagram showing a manner in which two electrical insulation sheet elements are formed out of one belt-shaped electrical insulation sheet in an intermediate process for forming a second modification of the protrusion-equipped electrical insulation sheet in the embodiment of the invention.

### DETAILED DESCRIPTION OF EMBODIMENTS

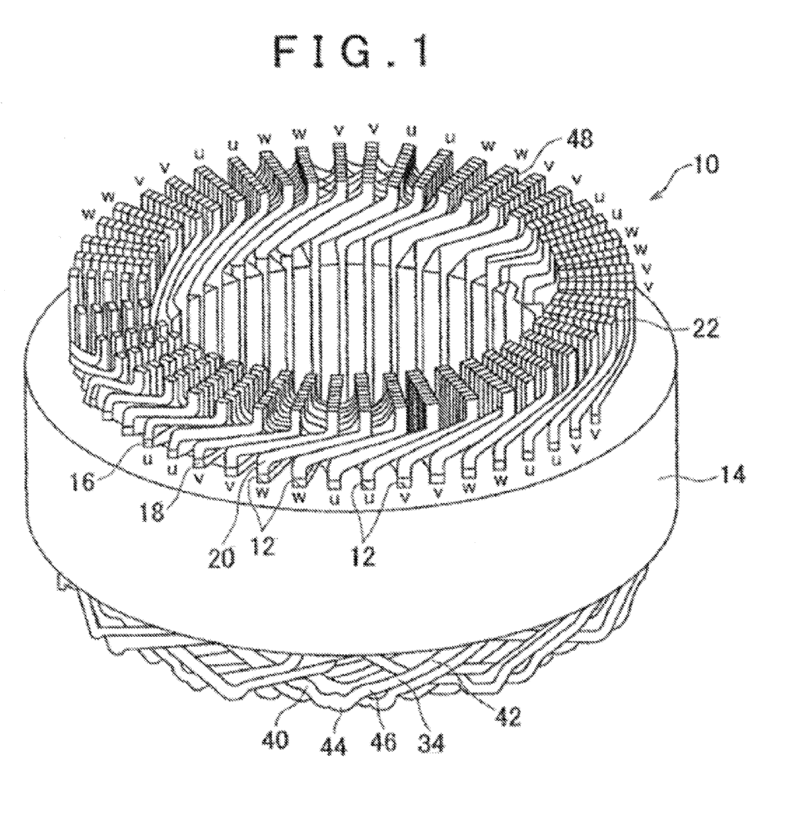

Hereinafter, embodiments of the invention will be described with reference to FIGS. 1 to 11B. A rotary electric machine stator (hereinafter, simply referred to as “stator”) of an embodiment is used to construct a rotary electric machine, such as an electric motor or an electricity generator. A stator 10 includes an annular stator core 14 made of a magnetic material, and a plurality of phases of annular segment assembly portions, concretely, three phase annular segment assembly portions 16, 18 and 20 of a U-phase, a V-phase and a W-phase that are wound on the stator core 14 in a distributed winding manner. When the stator 10 is used, a rotor (not shown) fixed to a rotary shaft is disposed radially inwardly of the stator 10 so that the stator 10 and the rotor face each other in the radial directions, whereby a radial type rotary electric machine is constructed. The stator core 14 is constructed of, for example, a dust core formed by pressure-molding a magnetic powder, or a stack of metal plates such as magnetic steel plates or the like, etc. The stator core 14 has, in its inner circumferential surface, slots 12 that are formed radially at a plurality of locations spaced from each other in the circumferential direction.

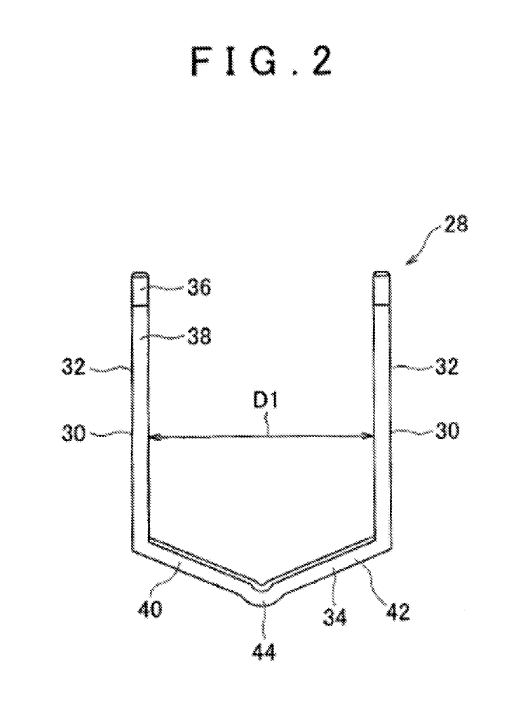

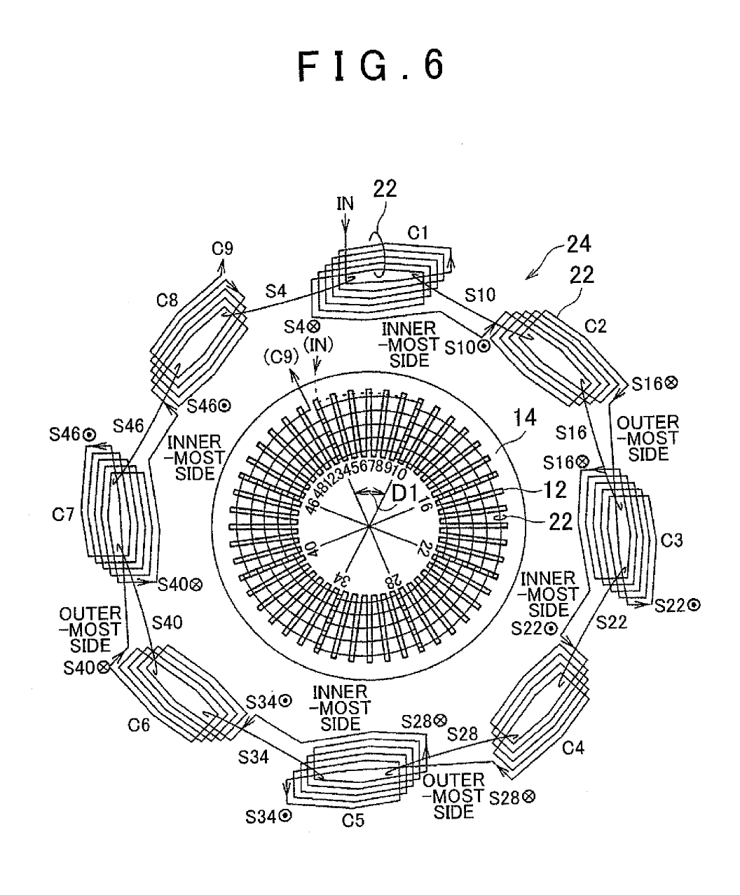

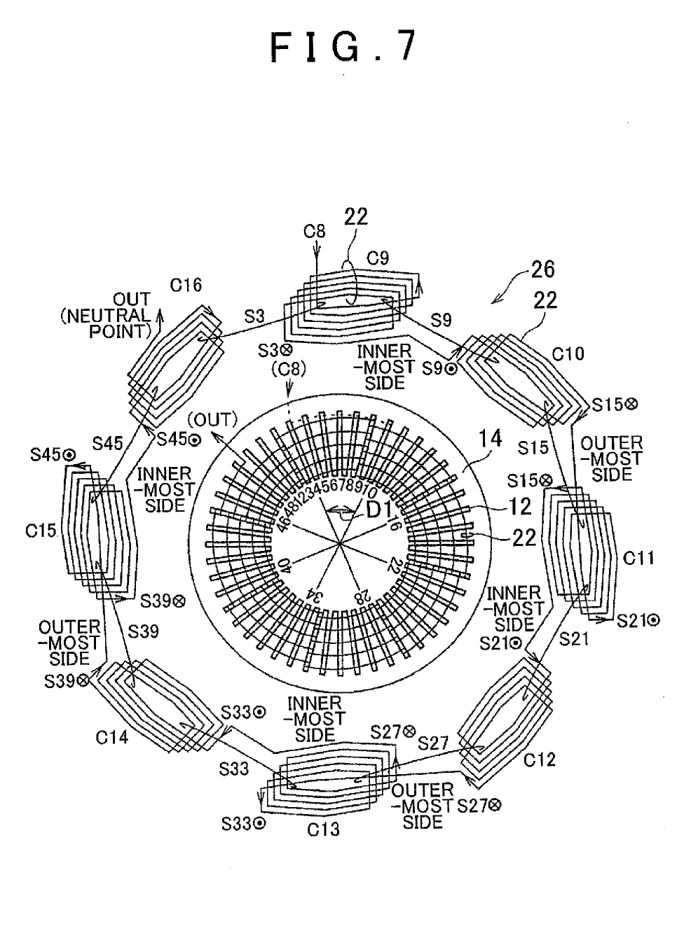

The annular segment assembly portions 16, 18 and 20 of the three phases are each formed by linking a plurality of segment coils 22 that are stator coils into an annular shape, and each annular segment assembly portion includes a first-round element 24 (FIG. 6) and a second-round element 26 (FIG. 7) that are connected to each other. Besides, each segment coil 22 is formed into a coil shape by arranging a plurality of generally U-shaped conductor segments 28 as shown in FIG. 2 and interconnecting the conductor segments 28, that is, joining them. Each conductor segment 28 has a two parallel leg portions 32 at two opposite ends in a width direction (right-left direction in FIG. 2), and a turn portion 34 that interlinks one ends of the leg portions 32. The leg portions 32 each have a straight portion 30 that is inserted into a corresponding one of two slots 12 (FIG. 1). The turn portion 34 has a one-side inclined portion 40 that is linked to an end (a lower end in FIG. 2) of a one-side leg portion 32 (a left-side leg portion in FIG. 2) of the two leg portions 32 in a direction oblique relative to the length direction of the leg portion 32, an other-side inclined portion 42 that is linked to an end (a lower end in FIG. 2) of the other-side leg portion 32 (the right-side leg portion in FIG. 2) of the leg portions 32 in a direction oblique relative to the length direction of the leg portion 32 toward the side opposite to the side toward which the one-side inclined portion 40 is oblique, and a linking portion 44 that interlinks the one-side inclined portion 40 and the other-side inclined portion 42. Besides, in each conductor segment 28, the peripheral surfaces of a conductor line 36, except two end portions thereof, are coated with an electrical insulation coating 38 that is an electrically insulating portion, such as an enamel resin or the like made of polyamideimide or the like.

That is, the stator 10 (FIG. 1) in this embodiment is of a so-called “segment coil winding type” that is provided with a plurality of segment coils 22 (FIG. 1) formed by coiling a coil wire obtained by coating the conductor line 36 that is a square wire having a rectangular cross-sectional shape, such as a flat rectangular wire or the like, with the insulation coating 38. A plurality of segment coils 22 are linked in the circumferential direction of the stator core 14 for at least one round (two rounds in this embodiment) so as to form each one of the three phase annular segment assembly portions 16, 18 and 20 (FIG. 1). In FIG. 1, reference characters “u”, “v” and “w” represent the U-phase, the V-phase and the W-phase, respectively.

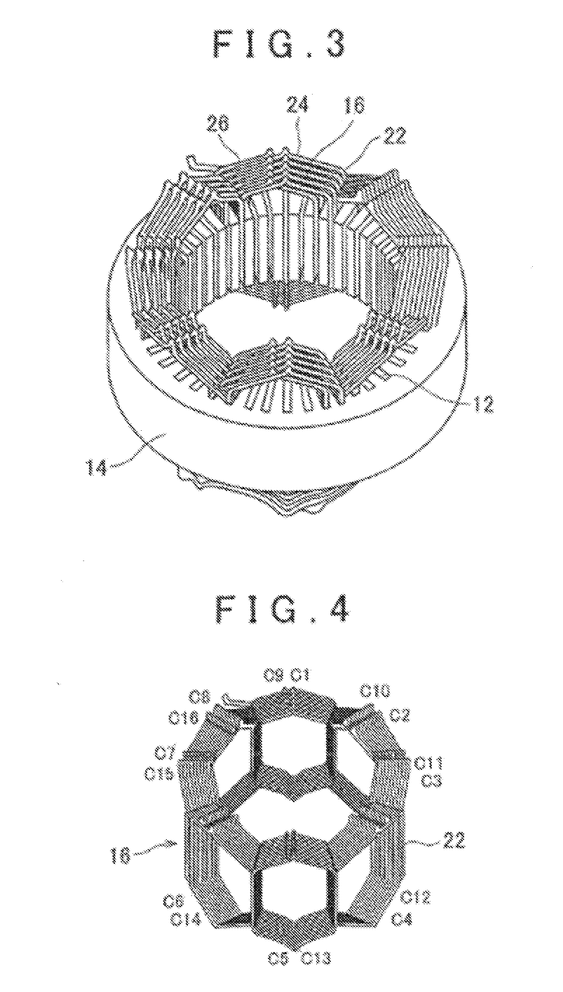

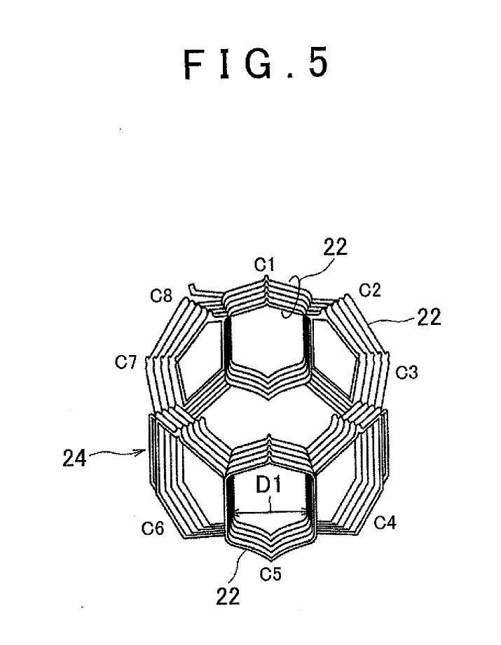

FIG. 3 is a schematic perspective view of the stator 10 shown in FIG. 1, showing a state in which the annular segment assembly portion 16 of the U-phase, that is, the annular segment assembly portion of one phase, is wound on the stator core 14. The annular segment assembly portions 16, 18 and 20 of the three phases (hereinafter, the annular segment assembly portion 16 of the U-phase will be described as a representative) are constructed as follows. Eight segment coils 22 that are unit coils whose width in the circumferential direction of the stator core 14 is a predetermined unit coil interval D1 (FIG. 5) are wound on the stator core 14 so that the eight segment coils 22 are interlinked in an annular shape to make one round on the stator core 14 and thus form a first-round element 24. Subsequently, other eight segment coils 22 are wound on the stator core 14 so as to be interlinked in an annular shape to make another round on the stator core 14 and thus form a second-round element 26. In this manner, the annular segment assembly portion 16 is constructed. In this case, the slots 12 in which the first-round element 24 is disposed and the slots 12 in which the second-round element 25 is disposed are shifted by one slot from each other in the circumferential direction.

FIG. 4 is a diagram in which the annular segment assembly portion 16 of the U-phase is extracted for illustration. Incidentally, the basic shape of the annular segment assembly portions 18 and 20 of the V-phase and the W-phase are substantially the same as that of the U-phase. The annular segment assembly portion 16 of the U-phase is constructed by combining sixteen segment coils 22 that are unit coils formed by coiling the coil wire. In FIG. 4, C1, C2 . . . C16 are coil numbers for distinguishing among the sixteen segment coils 22, and the segment coil C1 is the first unit coil in which the winding of the U-phase annular segment assembly portion 16 begins, and the segment coil C16 is the sixteenth unit coils in which the winding ends.

As shown in FIG. 4, the segment C2 is disposed next to the segment coil C1, and subsequently, the coils C3, C4 . . . , C16 are sequentially disposed next to the previously disposed one so as to make two rounds in the circumferential direction. Therefore, the ith coil and the (i+8)th coil where i is a coil number overlap partially with each other in the circumferential direction with a one-slot shift therebetween.

FIG. 5 is a diagram in which the first-round element 24 of the annular segment assembly portion 16 shown in FIG. 4 is extracted for illustration. The first-round element 24 of the annular segment assembly portion 16 is formed of annularly linking eight segment coils 22. Each segment coil 22 is constructed of a plurality of conductor segments 28. In FIG. 5, of the segment coils 22, the ninth to sixteenth segment coils 22 of the second-round element 26 (see FIG. 7) are omitted from illustration. However, the second-round element 26 is substantially the same in basic shape as the first-round element 24 shown in FIG. 5 while the second-round element 26 is shifted in position from the first-round element 24 in the circumferential direction.

FIG. 6 is a schematic diagram illustrating a manner in which the first-round element 24 of the annular segment assembly portion 16 shown in FIG. 4 is disposed on the stator core 14. FIG. 7 is a schematic diagram illustrating a manner in which the second-round element 26 of the annular segment assembly portion 16 shown in FIG. 4 is disposed on the stator core 14. In FIG. 7, the first-round element 24 shown in FIG. 6 is omitted from illustration. Incidentally, FIGS. 6 and 7 each show a plan view of the stator core 14, and a schematic illustration of a plurality of segment coils 22 surrounding the plan view. The segment coils 22 are wound at a plurality of locations on the stator core 14 so that each segment coil 22 is inserted into two slots 12 that are apart from each other by a certain number of slots 12 in the circumferential direction. The two slots 12 of each segment coil 22 are apart by a predetermined unit coil interval D1. Hereinafter, the segment coils 22 will be sometimes described with assigned coil numbers. In FIG. 6, the segment coil C1 is the coil where the winding of the annular segment assembly portion 16 (FIG. 4) starts, and is connected to an input terminal side (IN side) that is the power line side of the rotary electric machine.

The segment coil C1 is formed in a coil shape by winding a coil wire a plurality of turns between the slots S4 and S10. The winding of the segment coil C1 starts at the radially outer side of the stator core 14, which is the input terminal side, and the coil wire is wound through the two slots 12 so that the winding progresses from the radially outer side to the radially inner side. Next, at the winding end of the segment coil C1, the coil wire is connected to the segment coil C2. That is, at the winding end of the segment coil C1, the coil wire is jumped from the slot S10 to the slot S16 that is apart the slot S10 by the unit coil interval D1, and then the coil wire is wound between the slot S10 and the slot S16 a plurality of turns so as to form a coil shape. In this manner, the segment coil C2 is constructed. Then, this process is repeated to form the segment coils C1 to C8, so that the first-round element 24 is constructed.

The winding end of the first-round element 24 is connected, at the radially outermost side of the stator core 14, to the segment coil C9 of the second-round element 26 shown in FIG. 7. At this time, the segment coil C9 is formed in a coil shape by winding the coil wire a plurality of turns between the slot S3 and the slot S9 with a one-slot shift from the segment coil C1. Next, at the winding end of the segment coil C9, the coil wire is connected to the segment coil C10. That is, at the winding end of the segment coil C9, the coil wire is jumped from the slot S9 to the slot S15 that is apart from the slot S9 by the unit coil interval D1, and then is wound a plurality of turns between the slots S9 and S15 so as to form a coil shape, so that the segment coil C10 is constructed. Subsequently, this process is repeated to form the segment coils C9 to C16, so that the second-round element 26 is constructed.

Besides, the winding end of the segment coil C16 is drawn out of the radially outermost side of the stator core 14, and is connected to a neutral point of the rotary electric machine. In FIG. 7, the winding end of the segment coil C16 is shown as OUT (neutral point). Thus, the slots 12 in which the first-round element 24 of the annular segment assembly portion 16 is disposed and the slots 12 in which the second-round element 26 of the annular segment assembly portion 16 is disposed are shifted from each other in the circumferential direction. While the annular segment assembly portion 16 of the U-phase has been described, the annular segment assembly portions 18 and 20 of the V-phase and the W-phase are constructed substantially in the same manner, and as shown in FIG. 1, the slots 12 in which the V-phase annular segment assembly portion 18 is disposed are shifted by two slots in the circumferential direction from the slots 12 of the U-phase annular segment assembly portion 18, and the slots 12 in which the W-phase annular segment assembly portion 20 is disposed are shifted by further two slots in the circumferential direction.

When the annular segment assembly portions 16, 18 and 20 of the three phases are constructed, a plurality of generally U-shaped conductor segments 28, one of which is described above with reference to FIG. 2, are used. That is, a segment coil 22 is constructed by linking a plurality of the conductor segments 28, and the annular segment assembly portions 16, 18 and 20 of the three phases are constructed by interconnecting, that is, interlinking, a plurality of segment coils 22. In this case, each conductor segment 28 has, at two opposite end portions thereof, two parallel leg portions 32 that are provided at an interval therebetween that is equal to the unit coil interval Dl. An end of one of the two leg portions 32 and an end of the other leg portion 32 are interlinked by a turn portion 34. To construct each one of the segment coils 22 (FIG. 1), a plurality of conductor segments 28, for example, five conductor segments 28, are inserted into two slots 12 that are apart from each other by the predetermined unit coil interval D1 in the circumferential direction, from one side of the stator core 14 (the lower side thereof in FIG. 1) to the other side (the upper side in FIG. 1) thereof in the axial direction so that the conductor segments 28 are aligned in the radial directions in the two slots 12. Then, portions of distal end portions of the two leg portions 32 of each conductor segment 28 that are protruded from the other side of the stator core 14 in the axial direction are bent to such sides as to face each other in the circumferential direction (the “circumferential direction” (as well as “circumferentially”) refers to a circumferential direction of the stator unless otherwise stated, and this applies throughout the specification and the claims). Furthermore, a portion in the distal end portion of a one-side leg portion 32 of one conductor segment 28 which is bent into the axial direction (the up-down direction in FIG. 1) (the “axial direction” (as well as “axially”) refers to the axial direction of the stator unless otherwise stated, and this applies throughout the specification and the claims) and an axially bent portion in the distal end portion of the other-side leg portion 32 of another conductor segment 28 adjacent to the aforementioned one conductor segment 28 in the radial direction (the “radial direction” (as well as “radially”) refers to the direction of a radius of the stator, and this applies throughout the specification and the claims) are connected together by welding, such as TIG welding or the like. Thus, a one-side leg portion 32 of one conductor segment 28 and the other-side leg portion 32 of another conductor segment 28 radially adjacent to the one conductor segment 28 are connected together. By repeating this process for each conductor segment 28, a coil-shaped segment coil 22 is formed.

Besides, as shown in FIG. 1, in a state where the annular segment assembly portions 16, 18 and 20 of the three phases are mounted to the stator core 14, portions of the segment coils 22 that are protruded out from the two opposite end surfaces of the stator core 14 in the axial direction form a turn portion-side coil end portion 46 and a joint portion-side coil end portion 48 that are two coil end portions on the two axially opposite sides. The turn portion-side coil end portion 46, that is, a one-side coil end portion, is formed of turn portion 34-side portions of the segment coils 22. The joint portion-side coil end portion 48 is formed of distal end-side portions of the leg portions 32 (FIG. 2) that are on the joint portion side of the segment coils 22.

Besides, a portion of each conductor segment 28 that forms the turn portion-side coil end portion 46 includes a one-side inclined portion 40 that extends in an inclined direction such that the more the position becomes outer side (a lower side in FIG. 1) in the axial direction, the more the one-side inclined portion 40 extends to one side in the circumferential direction, and an other-side inclined portion 42 that is linked to the one-side inclined portion 40 via a linking portion 44 and that extends in an inclined direction such that the more the position becomes outer side in the axial direction, the more the other-side inclined portion 42 extends to the other side in the circumferential direction.

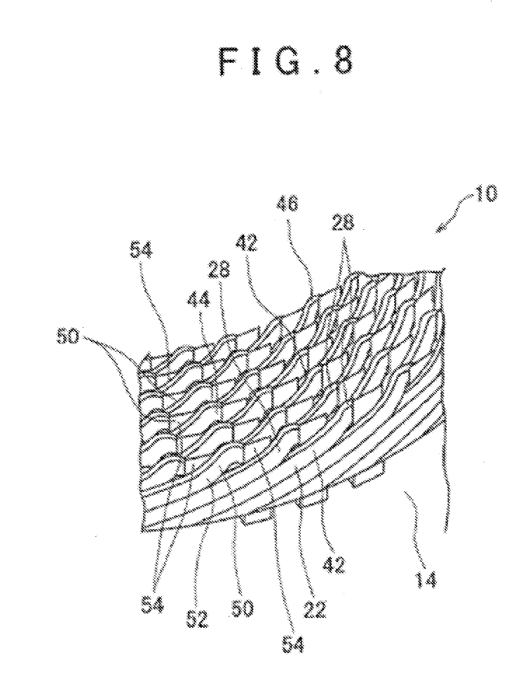

Furthermore, as shown in FIG. 8, the stator 10 has, in the turn portion-side coil end portion 46, a plurality of protrusion-equipped electrical insulation sheets 50 that are provided apart from each other in the radial directions of the turn portion-side coil end portion 46 so that each sheet 50 is inserted between two radially adjacent conductor segments 28 and, more specifically, between the one-side inclined portion 40 (FIGS. 1 and 2) of one of the two conductor segments 28 and the other-side inclined portion 42 of the other one of the two conductor segments 28.

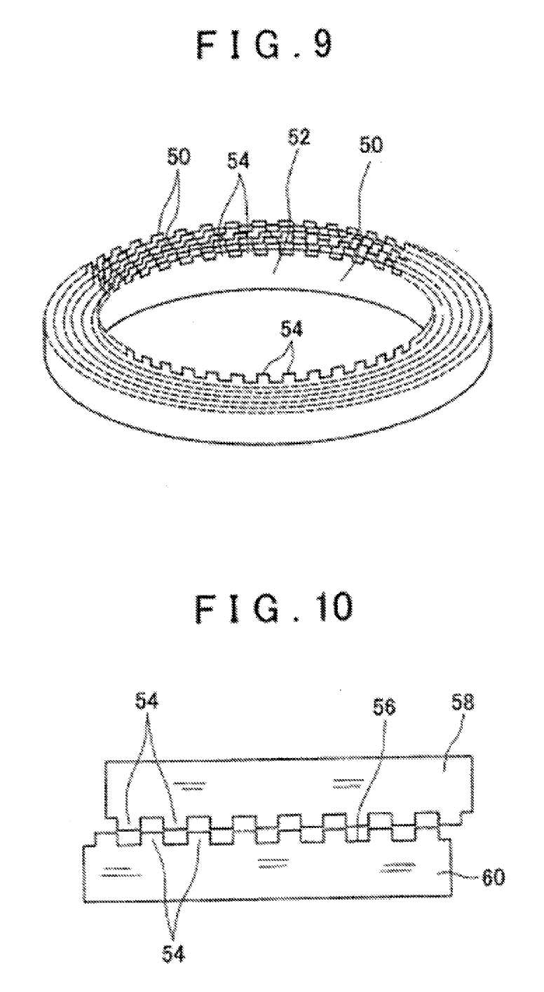

FIG. 9 is a perspective view showing a plurality of protrusion-equipped electrical insulation sheets 50 of annular shapes that are disposed in the turn portion-side coil end portion 46 of the stator 10 shown in FIG. 1. The protrusion-equipped electrical insulation sheets 50 are electrically insulating members that are formed in generally hollow cylindrical shapes that are different in diameter from each other. Each protrusion-equipped electrical insulation sheet 50 includes an annular main body portion 52 formed in an annular shape, and a plurality of protrusions 54 that are protruded in a width direction of the annular main body portion 52 from an end edge of the annular main body portion 52, that is, an end thereof in terms of the width direction, at a plurality of locations on the end edge that are spaced from each other in the length direction of the annular main body portion 52 that coincides with the circumferential direction. For example, the protrusions 54 can be provided at a plurality of locations that are equidistantly spaced from each other in the circumferential direction on the end edge of the protrusion-equipped electrical insulation sheet 50 in its width direction. The protrusion-equipped electrical insulation sheets 50 constructed as described above are made of an electrically insulation material such as a resin having electrically insulating property or the like, for example, polyphenylene sulfide (PPS) or the like. Each protrusion-equipped electrical insulation sheet 50 is formed in an annular shape by joining two longitudinally opposite end portions of a belt-shaped member made of an electrically insulating material by ultrasonic welding or the like. Besides, as shown in FIG. 8, each protrusion 54 is disposed between a portion of the one-side inclined portion 40 (FIG. 1) of one conductor segment 28 which portion is relatively close to the linking portion 44 and a portion of the other-side inclined portion 42 of another conductor segment 28 circumferentially adjacent to the one conductor segment 28 which portion is relatively close to the linking portion 44 of the another conductor segment 28 and which portion faces the portion of the one-side inclined portion 40 of the one conductor segment 28 in the radial direction or a direction oblique to the radial direction.

For example, as shown in FIG. 10, two electrical insulation sheet elements 58 and 60 obtained by cutting a belt-shaped electrical insulation sheet through a cutting portion 56 having a rectangular wave shape that is a wave shape at the middle in the width direction (up-down direction in FIG. 10) orthogonal to the length direction (left-right direction in FIG. 10) of the sheet may be used to form protrusion-equipped electrical insulation sheets 50. For example, a protrusion-equipped electrical insulation sheet 50 can be formed by joining two longitudinally opposite end portions of the electrical insulation sheet element 58 of the two sheet elements 58 and 60. In this case, of the two electrical insulation sheet elements 58 and 60, the other electrical insulation sheet element 60 can also be used to form another protrusion-equipped electrical insulation sheet 50 by joining two longitudinally opposite end portions of the electrical insulation sheet element 60. Thus, a plurality of protrusion-equipped electrical insulation sheets 50 can be formed out of one electrical insulation sheet, and the yield can be improved.

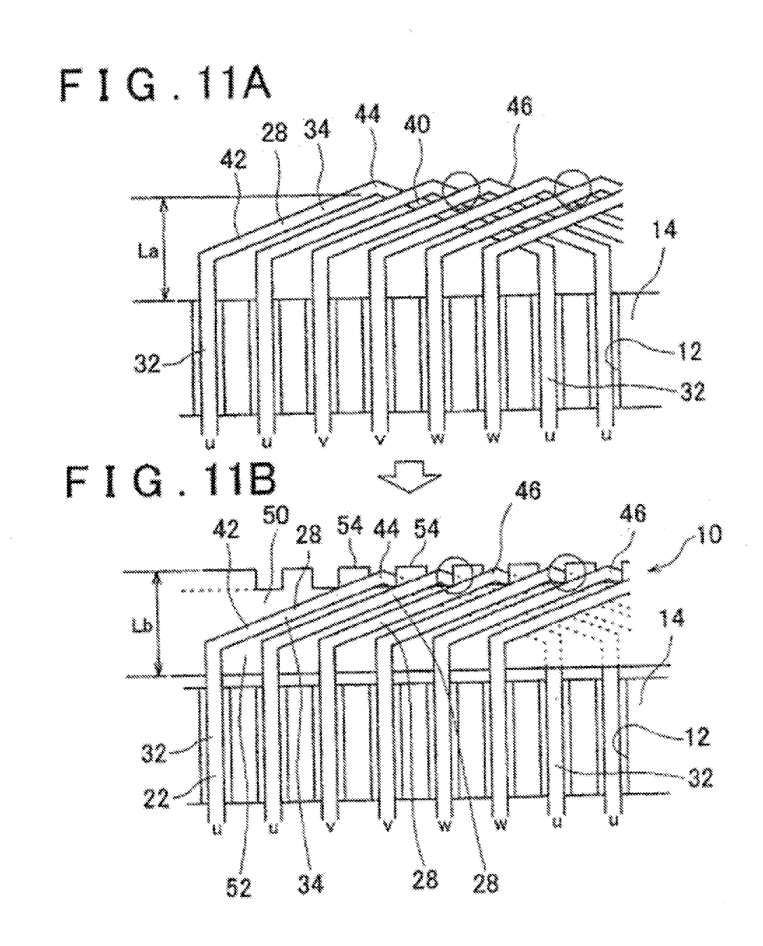

Next, with reference to FIGS. 11A and 11B, a method of disposing a protrusion-equipped electrical insulation sheet 50 in the turn portion-side coil end portion 46 will be described. FIGS. 11A and 11B are schematic views of the stator core 14 and the turn portion-side coil end portion 46 of the stator shown in FIG. 1 which are viewed from an outer peripheral side, before a protrusion-equipped electrical insulation sheet is disposed (FIG. 11A), and after the protrusion-equipped electrical insulation sheet 50 has been disposed (FIG. 11B). As shown in FIG. 11A, the turn portions 34 of conductor segments 28 are provided in the turn portion-side coil end portion 46. The turn portion 34 of each conductor segment 28 has a one-side inclined portion 40 and an other-side inclined portion 42 that are inclined in opposite directions relative to the axial direction of the stator 10. Therefore, an inclined portion 40 (or 42) of one conductor segment 28 intersects with inclined portions 42 (or 40) of other plurality of conductor segments 28 at a plurality of locations in radial directions (the direction perpendicular to the sheet of the drawings of FIGS. 11A and 11B) so as to face the other plurality of conductor segments 28 in radial directions.

To dispose the protrusion-equipped electrical insulation sheets 50 in the turn portion-side coil end portion 46, firstly, as a pre-stage process, the leg portions 32 of a plurality of U-shaped conductor segments 28 are inserted into corresponding slots 12 in the axial direction, that is, from one side (the upper side in FIGS. 11A and 11B) of the stator core 14 to the other side thereof in the axial direction. Besides, a length La from the turn portion 34-side end surface of the stator core 14 (the upper end surface thereof in FIG. 1) to an inner-side edge portion of a top portion of the turn portion 34 is maintained so as to be greater than a width Lb of the protrusion-equipped electrical insulation sheet 50 that includes the distal ends of the protrusions 54 (FIG. 11B) (La>Lb).

Next, an electrical insulation sheet element 58 (or 60) (FIG. 10) is inserted sequentially between every two radially adjacent ones of the conductor segments 28 that are present at a plurality of locations in the circumferential direction and at substantially the same positions in the radial direction of the turn portion-side coil end portion 46, and is formed in an annular shape such as to extend throughout the annular turn portion-side coil end portion 46, and two longitudinally opposite end portions of the electrical insulation sheet element 58 (or 60) are joined by welding, so as to form a protrusion-equipped electrical insulation sheet 50. In this case, positional arrangement is made such that each of the protrusions 54 provided on the electrical insulation sheet element 58 (or 60) exists between the top portions of the turn portions 34 of two circumferentially adjacent conductor segments 28 (adjacent to each other in the circumferential direction), and coincides, in the circumferential direction, with a portion of the one-side inclined portion 40 of one of the conductor segments 28 and a portion of the other-side inclined portion 42 of the other one of the conductor segments 28, the portion of the one-side inclined portion 40 and the portion of the other-side inclined portion 42 facing each other in a radial direction. Besides, this process is repeated for one or more other electrical insulation sheet elements 58 (or 60) that are apart in the radial direction from the aforementioned electrical insulation sheet element 58, so that a plurality of protrusion-equipped electrical insulation sheets 50 different in diameter are mounted at a plurality of sites that are apart from each other in the radial direction in the turn portion-side coil end portion 46.

Next, as shown in FIG. 11B, the leg portions 32 of the conductor segments 28 are further inserted into corresponding slots 12 from the one side of the stator core 14 to the other side thereof in the axial direction (from the upper side to the lower side in FIG. 11B). Then, arrangement is made such that each of the plurality of protrusions 54 of each protrusion-equipped electrical insulation sheet 50 is disposed between the top portions of the turn portions 34 of two circumferentially adjacent conductor segments 28 and, more specifically, between a portion of the one-side inclined portion 40 of one of the conductor segments 28 and a portion of the other-side inclined portion 42 of the other one of the conductor segments 28, the portion of the one-side inclined portion 40 and the portion of the other-side inclined portion 42 facing each other in a radial direction. After that, in the joint portion-side coil end portion 48 that is axially opposite to the turn portion-side coil end portion 46, a second electrical insulation sheet (not shown) of a simple annular shape with its two axially opposite end edges being simply flat, that is, not being provided with any protrusion, is disposed at each of a plurality of sites that are spaced from each other in the radial direction. In this state, each one of the second electrical insulation sheets is inserted between two radially adjacent ones of conductor segments 28 that exist at a plurality of locations in the circumferential direction. After that, distal end portions of the leg portions 32 of each conductor segment 28 are bent in directions oblique to the circumferential direction, and distal end (tip) portions of the bent portions are bent so as to extend in the axial direction. Then, a distal end portion of one conductor segment 28 which is not coated with the insulation coating 38 and a non-insulated distal end portion (not coated with the insulation coating 38) of another conductor segment 28 apart from the one conductor segment 28 in the radial or circumferential direction are joined by welding or the like. In this manner, the stator 10 is formed.

Due to the above-described mounting of the protrusion-equipped electrical insulation sheet 50 in the turn portion-side coil end portion 46, each protrusion-equipped electrical insulation sheet 50 is inserted between two radially adjacent conductor segments 28 in the turn portion-side coil end portion 46, and is inserted inside the portion of each of the conductor segments 28, the portion forming the turn portion-side coil end portion 46. Besides, the protrusions 54 of each protrusion-equipped electrical insulation sheet 50 are provided so as to protrude in the axial direction from the end edge of the annular main body portion 52, the end edge being positioned axially opposite to the stator core 14 with respect to the annular main body portion 52.

Besides, at a plurality of sites in the circumferential direction in the turn portion-side coil end portion 46, the protrusions 54 of the protrusion-equipped electrical insulation sheets 50 are each disposed between a portion of the one-side inclined portion 40 of one conductor segment 28 which portion is relatively close to the linking portion 44 and a portion of the other-side inclined portion 42 of another conductor segment 28 circumferentially adjacent to the one conductor segment 28 which portion is relatively close to the linking portion 44 of the another conductor segment 28 and which portion faces the portion of the one-side inclined portion 40 of the one conductor segment 28. Furthermore, protrusions 54 are disposed at a plurality of locations that are on the end edge of the annular main body portion 52 in the axial direction and at each of which locations, portions of two adjacent segment coils 22 which portions form the turn portion-side coil end portion 46 face each other in the radial direction. Therefore, at least part of the protrusions 54 are provided at positions which are between different phase coils 22, that is, between the segment coils 22 of different phases, through which different-phase electric currents flow during use, and at which positions, the interval between the two coils becomes relatively small.

According to the stator 10 described above, in a construction that has segment coils 22 each of which is formed of conductor segments 28, it can be made easy to interpose protrusions 54 of each protrusion-equipped electrical insulation sheet 50 between two segment coils of different phases in the turn portion-side coil end portion 46 even at a position where, when a simple circularly annular shaped electrical insulation sheet is used, the electrical insulation sheet cannot be interposed between the two segment coils that are close to each other. Therefore, the interphase partial discharge inception voltage (PDIV) in the turn portion-side coil end portion 46 is effectively improved.

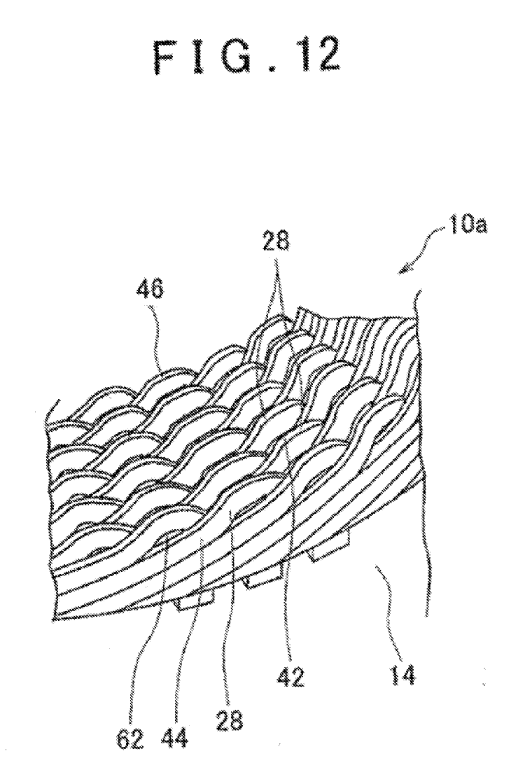

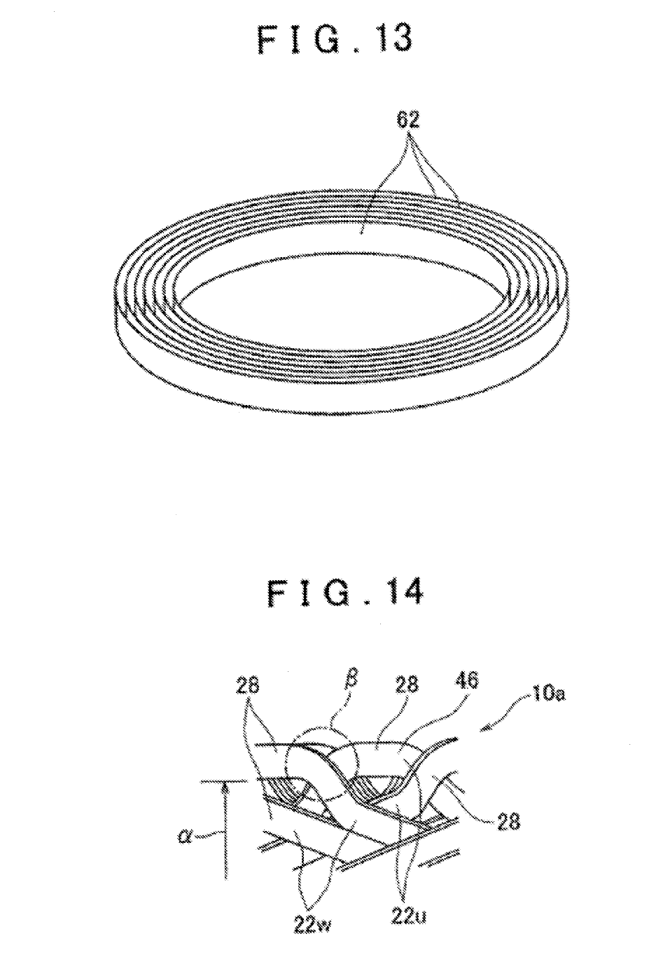

To describe this effect, a stator 10a of a comparative example based on a construction similar to that of the foregoing embodiment in which, in the turn portion-side coil end portion 46, the protrusion-equipped electrical insulation sheets 50 are replaced by electrical insulation sheets that are formed in a simple annular shape without any protrusion 54 will be firstly described with reference to FIGS. 12 to 14. FIG. 12 is a diagram showing the stator 10a of the comparative example and corresponding to FIG. 8. FIG. 13 is a perspective view of a plurality of annular electrical insulation sheets 62 that are to be disposed in the turn portion-side coil end portion 46 in the stator 10a of the comparative example shown in FIG. 12. FIG. 14 is a diagram showing a location where the interphase PDIV of adjacent coils becomes small in the turn portion-side coil end portion 46 in the comparative example shown in FIG. 12 while omitting illustration of an electrical insulation sheet.

In the case where the annular electrical insulation sheets 62 shown in FIG. 13 are disposed at a plurality of radially apart positions in the turn portion-side coil end portion 46 as shown in FIG. 12, there can be a construction in which two segment coils 22u that are two in-phase coils and two segment coils 22w, second in-phase coils, that are also in phase with each other and out of phase from the two segment coils 22u are disposed so as to radially face each other in the turn portion-side coil end portion 46 partially with respect to the circumferential direction as shown in FIG. 14. This construction will be considered. In this construction, if a simple annular electrical insulation sheet 62 (FIG. 13) with the two axially opposite ends being flat is disposed between the segment coils 22u and 22w, that is, between coils of different phases, the electrical insulation sheet 62 is disposed only in a range indicated by an arrow a in FIG. 14 in terms of the axial direction of the stator 10a, and the electrical insulation sheet 62 is not disposed in at least a portion of a region enclosed in a circle β in FIG. 14. Therefore, in the comparative example, there occurs a reduced interphase PDIV between the adjacent coils, that is, reduced partial discharge inception voltage between phases, in a region enclosed in the circle β.

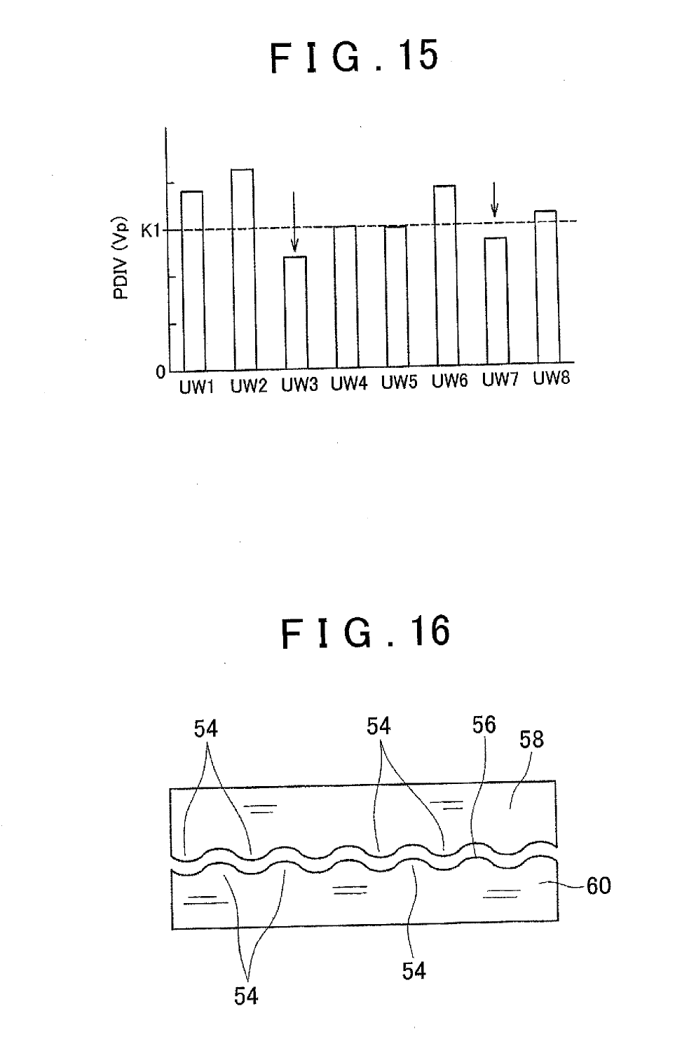

For example, FIG. 15 is a diagram showing interphase PDIVs between pairs of a U-phase conductor segment 28 and a W-phase conductor segment 28 that are radially adjacent to each other, that is, between different phases, in a region in the circumferential direction, in the comparative example shown in FIG. 12. In FIG. 15, UW1, UW2 . . . on the horizontal axis indicate the interphase PDIVs (Vp) between a U-phase conductor segment 28 and a W-phase conductor segment 28 at different locations in the radial direction in a region of the turn portion-side coil end portion 46 in the circumferential direction, in the order of disposition in the radial direction. Besides, K1 in FIG. 15 is a lower limit value of interphase PDIV that is set beforehand for a design reason. As is apparent from FIG, 15, the PDIVs are less than the lower limit value K1 at UW3 and UW7 as indicated by downward arrows in FIG. 15, and it can be understood that there are two points or locations in the radial direction of the stator 10a at which the interphase PDIV does not reach the lower limit value K1.

In contrast, according to the embodiment shown in FIGS. 1 to 11B, due to the protrusions 54 (FIGS. 8 and 9), the protrusion-equipped electrical insulation sheets 50 (FIGS. 8 and 9) are provided between conductor segments 28 of different phases even in a region that corresponds to the region enclosed in the circle β in FIG. 14. Specifically, in FIG. 11A, regions indicated by circles are regions in which different-phase coils radially face directly each other (without an intervention of an electrical insulation sheet 62) even when an electrical insulation sheet 62 (FIG. 13) of the comparative example is provided between the different-phase coils. On the other hand, in the embodiment, protrusions 54 are interposed even between portions of conductor segments 28 that are indicated by circles in FIG. 11B. Therefore, it is possible to effectively improve the interphase PDIV in the turn portion-side coil end portion 46 without increasing the size of the stator 10. For example, it is possible to improve the interphase PDIV by bringing a protrusion 54 into contact with portions of two radially adjacent conductor segments 28 where the interphase PDIV tends to decline.

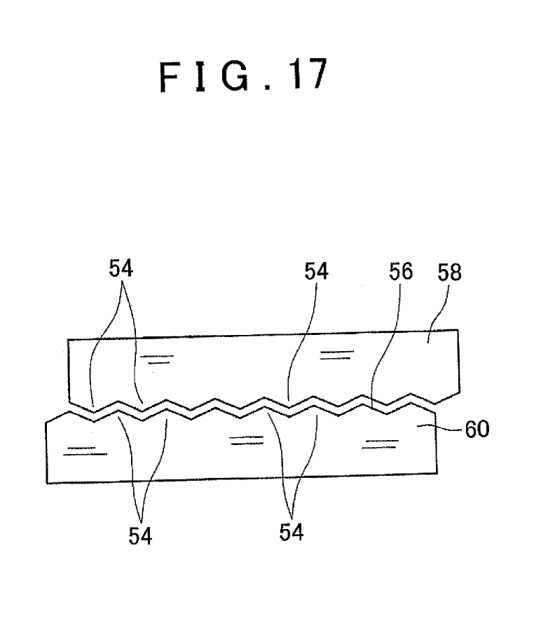

Incidentally, in this embodiment, the shape of the protrusions 54 provided on each protrusion-equipped electrical insulation sheet 50 (FIG. 9) is not limited to the shape described above with reference to FIGS. 9 and 10. For example, FIGS. 16 and 17 show intermediate processes of formation of first and second modifications, respectively, of the protrusion-equipped electrical insulation sheet of the embodiment of the invention in which two electrical insulation sheet elements 58 and 60 are formed out of one belt-shaped electrical insulation sheet. Thus, the shape of the protrusions 54 can be, for example, an arc shape (FIG. 16) or a triangular shape (FIG. 17). Besides, in this case, as shown in FIG. 16, two electrical insulation sheet elements 58 and 60 obtained by cutting a belt-shaped electrical insulation sheet through a cutting portion 56 having an wave shape in which an arc edge shape repeats (a type of wave shape) at the middle in the width direction (up-down direction in FIG. 16) orthogonal to the length direction (left-right direction in FIG. 16) of the sheet may be used to form protrusion-equipped electrical insulation sheets. A protrusion-equipped electrical insulation sheet can be formed by joining two longitudinally opposite end portions of one electrical insulation sheet element 58. Besides, the other electrical insulation sheet element 60 can also be used to form another protrusion-equipped electrical insulation sheet.

Furthermore, as shown in FIG. 17, two electrical insulation sheet elements 58 and 60 obtained by cutting a belt-shaped electrical insulation sheet through a cutting portion 56 having a sawtooth wave shape, that is, a triangular wave shape, at the middle in the width direction (up-down direction in FIG. 17) orthogonal to the length direction (left-right direction in FIG. 17) of the sheet may be used to form protrusion-equipped electrical insulation sheets. A protrusion-equipped electrical insulation sheet can be formed by joining two longitudinally opposite end portions of one electrical insulation sheet element 58. Besides, the other electrical insulation sheet element 60 can also be used to form another protrusion-equipped electrical insulation sheet.

In the embodiment, the protrusions 54 of the protrusion-equipped electrical insulation sheets 50 are disposed at all the positions that circumferentially coincide with positions between top portions of the turn portions 34 of circumferentially adjacent conductor segments 28, regardless of whether the adjacent conductor segments 28 are of the same phase or of different phases, and, more specifically, between a portion of the one-side inclined portion 40 of one of two circumferentially adjacent conductor segments 28 and a portion of the other-side inclined portion 42 of the other circumferentially adjacent conductor segment 28, the portion of the one-side inclined portion 40 and the portion of the other-side inclined portion 42 radially facing each other. However, on an axial end edge of a protrusion-equipped electrical insulation sheet 50, protrusions 54 may be provided only at positions that circumferentially coincide with positions between top portions of the turn portions 34 of circumferentially adjacent conductor segments 28 of different phases, and, more specifically, between a portion of the one-side inclined portion 40 of one of two circumferentially adjacent conductor segments 28 and a portion of the other-side inclined portion 42 of the other circumferentially adjacent conductor segment 28, the portion of the one-side inclined portion 40 and the portion of the other-side inclined portion 42 radially facing each other, that is, a configuration may be employed in which protrusions 54 are provided only between different phases. Besides, the second electrical insulation sheets that are disposed between radially adjacent conductor segments 28 in the joint portion-side coil end portion 48 can be constructed so as to have substantially the same shape as the protrusion-equipped electrical insulation sheets 50 disposed in the turn portion-side coil end portion 46, depending on circumstances. The conductor segments are not limited to U-shaped conductor segments. On the contrary, conductor segments of various shapes can be used as long as a plurality of conductor segments can be interconnected to form a coil shape.

A configuration may be employed, in which at least in a one-side coil end portion that is one of two coil end portions on two opposite sides of the stator core in the axial direction, the electrical insulation sheet is inserted between two conductor segments adjacent to each other in the radial direction and is inserted inside a portion of a conductor segment; the portion forming the one-side coil end portion.

A configuration may be employed, in which the protrusion is disposed at each of a plurality of locations that are on the end edge of the annular main body portion in the axial direction and that are between portions of two segment coils adjacent to each other in the circumferential direction, the portions forming the one-side coil end portion and facing each other in the radial direction.

A configuration may be employed, in which a portion of each of the conductor segments that forms the one-side coil end portion includes a one-side inclined portion that is inclined in a direction such that the more a position becomes outer side in the axial direction, the more the one-side inclined portion extends to one side in the circumferential direction, and an other-side inclined portion that is linked to the one-side inclined portion via a linking portion and that is inclined in a direction such that the more a position becomes outer side in the axial direction, the more the other-side inclined portion extends to the other side in the circumferential direction; the electrical insulation sheet is inserted between the one-side inclined portion and the other-side inclined portion; and the protrusion is disposed between a portion of the one-side inclined portion of one conductor segment which portion is relatively close to the linking portion and a portion of the other-side inclined portion of another conductor segment adjacent to the one conductor segment in the circumferential direction which portion is relatively close to the linking portion of the another conductor segment and which portion faces the portion of the one-side inclined portion of the one conductor segment.

A configuration may be employed, in which the protrusion is provided between the segment coils of different phases, through which currents of the different phases flow during use, at a position between the segment coils of different phases, at which position an interval between the segment coils is relatively small.

A configuration may be employed, in which the electrical insulation sheet is formed in an annular shape by joining two longitudinally opposite end portions of one of two electrical insulation sheet elements obtained by cutting a belt-shaped electrical insulation sheet through a cutting portion of a wave shape at a middle in a width direction orthogonal to a length direction of the belt-shaped electrical insulation sheet.

The invention has been described with reference to example embodiments for illustrative purposes only. It should be understood that the description is not intended to be exhaustive or to limit form of the invention and that the invention may be adapted for use in other systems and applications. The scope of the invention embraces various modifications and equivalent arrangements that may be conceived by one skilled in the art.

What is claimed is:

1. A rotary electric machine stator comprising:
a stator core having slots that are formed at a plurality of locations on an inner circumferential surface of the stator core that are spaced from each other in a circumferential direction of the stator core;
a plurality of annular segment assembly portions of phases wound on the stator core in a distributed winding manner, the annular segment assembly portion of each phase including a plurality of segment coils, each of which is formed in a coil shape by connecting a plurality of conductor segments to each other; and
an annular electrical insulation sheet inserted between two conductor segments adjacent to each other in a radial direction of the stator core in a coil end portion that is formed of portions of the plurality of segment coils, the portions protruding to an outer side in an axial direction of the stator core from an end surface of the stator core in the axial direction, wherein
the electrical insulation sheet includes an annular main body portion formed in an annular shape, and a protrusion that is provided on an end edge of the annular main body portion on a side opposite to the stator core side in the axial direction so that the protrusion is protruded in the axial direction from the end edge.

2. The rotary electric machine stator according to claim 1, wherein
at least in a one-side coil end portion that is one of two coil end portions on two opposite sides of the stator core in the axial direction, the electrical insulation sheet is inserted between two conductor segments adjacent to each other in the radial direction and is inserted inside a portion of a conductor segment, the portion forming the one-side coil end portion.

3. The rotary electric machine stator according to claim 2, wherein
the protrusion is disposed at each of a plurality of locations that are on the end edge of the annular main body portion in the axial direction and that are between portions of two segment coils adjacent to each other in the circumferential direction, the portions forming the one-side coil end portion and facing each other in the radial direction.

4. The rotary electric machine stator according to claim 2, wherein:
a portion of each of the conductor segments that forms the one-side coil end portion includes a one-side inclined portion that is inclined in a direction such that the more a position becomes outer side in the axial direction, the more the one-side inclined portion extends to one side in the circumferential direction, and an other-side inclined portion that is linked to the one-side inclined portion via a linking portion and that is inclined in a direction such that the more a position becomes outer side in the axial direction, the more the other-side inclined portion extends to the other side in the circumferential direction;
the electrical insulation sheet is inserted between the one-side inclined portion and the other-side inclined portion; and
the protrusion is disposed between a portion of the one-side inclined portion of one conductor segment which portion is relatively close to the linking portion and a portion of the other-side inclined portion of another conductor segment adjacent to the one conductor segment in the circumferential direction which portion is relatively close to the linking portion of the another conductor segment and which portion faces the portion of the one-side inclined portion of the one conductor segment.

5. The rotary electric machine stator according to claim 1, wherein
the protrusion is provided between the segment coils of different phases, through which currents of the different phases flow during use, at a position between the segment coils of different phases, at which position an interval between the segment coils is relatively small.

6. The rotary electric machine stator according to claim 1, wherein
the electrical insulation sheet is formed in an annular shape by joining two longitudinally opposite end portions of one of two electrical insulation sheet elements obtained by cutting a belt-shaped electrical insulation sheet through a cutting portion of a wave shape at a middle in a width direction orthogonal to a length direction of the belt-shaped electrical insulation sheet.
